(19) United States
(12) Patent Application Publication
(10) Pub. No.: US 2011/0008681 A1
(43) Pub. Date: Jan. 13, 2011

(54) ELECTROLYTIC SOLUTION

(76) Inventors: Meiten Koh, Settsu-shi (JP); Hitomi Nakazawa, Settsu-shi (JP); Hideo Sakata, Settsu-shi (JP); Michiru Tanaka, Settsu-shi (JP); Akiyoshi Yamauchi, Settsu-shi (JP); Aoi Nakazono, Settsu-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/677,397

(22) PCT Filed: Sep. 12, 2008
(86) PCT No.: PCT/JP2008/066552

§ 371 Date: Mar. 10, 2010

(30) Foreign Application Priority Data
Dec. 9, 2007 (JP) 2007-237171

(51) Int. Cl. H01M 10/05

(52) U.S. Cl. 429/331; 429/329; 429/332; 429/333

(57) ABSTRACT

There is provided an electrolytic solution causing no phase separation even at low temperatures, being excellent in flame retardancy and noncombustibility, assuring high solubility of an electrolyte salt, having a high discharge capacity, being excellent in charge-discharge cycle characteristics and being suitable for electrochemical devices such as lithium ion secondary batteries. The electrolytic solution comprises a solvent (I) for dissolving an electrolyte salt comprising a fluorine-containing ether (A) represented by the formula: Rf¹—O—Rf² (Rf¹ and Rf² are the same or different, Rf¹ is a fluorine-containing alkyl group having 3 to 6 carbon atoms, Rf² is a fluorine-containing alkyl group having 2 to 6 carbon atoms), at least one fluorine-containing solvent (B) selected from the group consisting of a fluorine-containing cyclic carbonate (B1) and a fluorine-containing lactone (B2), and at least one non-fluorine-containing carbonate (C) selected from the group consisting of (C1) a non-fluorine-containing cyclic carbonate and (C2) a non-fluorine-containing chain carbonate, and an electrolyte salt (II), and the solvent (I) for dissolving an electrolyte salt comprises 20 to 60% by volume of the fluorine-containing ether (A), 0.5 to 30% by volume of the fluorine-containing solvent (B), and 5 to 40% by volume of the non-fluorine-containing cyclic carbonate (C1) and/or 10 to 74.5% by volume of the non-fluorine-containing chain carbonate (C2) based on the whole solvent (I).

### TECHNICAL FIELD

The present invention relates to an electrolytic solution suitable for electrochemical devices such as lithium ion secondary batteries.

### BACKGROUND ART

Carbonates such as ethylene carbonate, propylene carbonate and dimethyl carbonate are generally used as a solvent for dissolving an electrolyte salt for lithium ion secondary batteries. However, these hydrocarbon carbonates are low in a flash point and have high combustibility, and therefore, there is a danger of firing and explosion due to over-charging and over-heating, which is an important problem to be solved for securing safety especially in the cases of large size lithium ion secondary batteries for hybrid cars and distributed power source.

For preventing explosion of an electrolytic solution, means for blending fluoroalkane, phosphoric ester or phosphorus compound as an additive to the electrolytic solution are proposed (cf., for example, JP11-233141A, JP11-283669A, JP2002-280061A and JP9-293533A).

However, in a system where fluoroalkane is added, fluoroalkane itself is hardly compatible with carbonates being essential as components of an electrolytic solution, thereby causing phase separation and deteriorating battery performance.

Also, in a system where phosphoric ester or phosphorus compound is added, combustibility of an electrolytic solution is inhibited, but viscosity becomes high, thereby easily causing decrease in conductivity and deterioration due to charge and discharge cycle.

In order to improve noncombustibility and flame retardancy of an electrolytic solution without lowering its performance, addition of a fluorine-containing ether has been proposed (cf., for example, JP8-37024A, JP9-97627A, JP11-26015A, JP2000-294281A, JP2001-52737A and JP11-307123A).

JP8-37024A describes an electrolytic solution for secondary batteries comprising a fluorine-containing ether and having high capacity and excellent cycle stability, and says that either of a fluorine-containing chain ether and a fluorine-containing cyclic ether may be used, and fluorine-containing ethers having an alkyl group having 2 or less carbon atoms at one end thereof are exemplified as examples of a fluorine-containing chain ether.

However, it is disclosed that the content of fluorine-containing ether is up to 30% by volume, and when the content is larger than 30% by volume, in such a system, discharge capacity becomes small.

In order to prepare an electrolytic solution without using a cyclic carbonate as a solvent for dissolving an electrolyte salt, JP9-97627A proposes to use, in addition to a non-cyclic carbonate, a fluorine-containing ether represented by R^{A}—O—R^{B} (R^{A} is an alkyl group or halogen-substituted alkyl group having 2 or less carbon atoms; R^{B} is a halogen-substituted alkyl group having 2 to 10 carbon atoms) in an amount of 30 to 90% by volume. Also it is suggested that initial discharge capacity is improved by blending a cyclic carbonate preferably in an amount of not more than 30% by volume, though blending of a cyclic carbonate is not essential.

However, it is said that in this system, when the number of carbon atoms of R^{A} is 3 or more, solubility of an electrolyte salt is lowered, and target battery characteristics cannot be obtained.

JP11-26015A, JP2000-294281A and JP2001-52737A propose improvement in compatibility with other solvents, stability for oxidation decomposition and noncombustibility by using a fluorine-containing ether having —CH₂—O— as an organic group having ether linkage-formable oxygen, and concretely disclose a fluorine-containing ether such as HCF₂CF₂CH₂OCF₂CF₂H having an organic group having 2 or less carbon atoms and being bonded to the ether linkage-formable oxygen. However, its boiling point is low on the whole, compatibility with other solvent is low and in addition, solubility of an electrolyte salt is low. Therefore, this fluorine-containing ether is not necessarily enough as a solvent for an electrolytic solution for secondary batteries in the case of aiming at further heat resistance and resistance to oxidation.

JP11-307123A describes that an electrolytic solution being excellent in keeping of capacity and safety can be provided by mixing a fluorine-containing ether represented by CₘF₂ₘ₊₁—O—CₙH₂ₙ₊₁ and a chain carbonate. However, this solvent mixture system is low in capability of dissolving an electrolyte salt and cannot dissolve LiPF₆ and LiBF₄ which are excellent electrolyte salts and are generally used. As a result, LiN(O₂SCF₃)₂ exhibiting corrosive behavior on metal is obliged to be used as an electrolyte salt. Also, rate characteristics are inferior because of high viscosity.

In addition, a fluorine-containing ether represented by R^{C}—O—R^{D} (R^{C} and R^{D} are the same or different and each is a fluorine-containing alkyl group) having fluorine-containing alkyl groups at both ends thereof is useful as a flame retardant for lithium ion secondary battery, but in order to secure sufficient flame retardancy, a content of not less than 30% by volume is required. In this case, when a content of ethylene carbonate which is a highly dielectric solvent is higher, lithium salt is easily precipitated, and on the contrary, when the content is smaller, ionic conductivity is decreased.

As mentioned above, the present situation is such that electrolytic solutions for lithium secondary battery being excellent in noncombustibility and flame retardancy and having sufficient battery characteristics (charge-discharge cycle characteristics, discharge capacity, ionic conductivity, etc.) have not been developed.

### DISCLOSURE OF INVENTION

The present invention was made aiming at solving the conventional problems mentioned above, and it is an object of the present invention to provide an electrolytic solution causing no phase separation even at low temperatures, being excellent in flame retardancy and noncombustibility, assuring high solubility of an electrolyte salt, having a high discharge capacity, being excellent in charge-discharge cycle characteristics and being suitable for electrochemical devices such as lithium ion secondary batteries.

Namely, the present invention relates to an electrolytic solution comprising:

(I) a solvent for dissolving an electrolyte salt comprising:
(A) a fluorine-containing ether represented by the formula (A):

Rf¹—O—R²

wherein Rf¹ and Rf² are the same or different, Rf¹ is a fluorine-containing alkyl group having 3 to 6 carbon atoms, Rf² is a fluorine-containing alkyl group having 2 to 6 carbon atoms,
(B) at least one fluorine-containing solvent selected from the group consisting of (B1) a fluorine-containing cyclic carbonate and (B2) a fluorine-containing lactone, and
(C) at least one non-fluorine-containing carbonate selected from the group consisting of (C1) a non-fluorine-containing cyclic carbonate and (C2) a non-fluorine-containing chain carbonate, and
(II) an electrolyte salt, and
the solvent (I) for dissolving an electrolyte salt comprises 20 to 60% by volume of the fluorine-containing ether (A), 0.5 to 45% by volume of the fluorine-containing solvent (B), and 5 to 40% by volume of the non-fluorine-containing cyclic carbonate (C1) and/or 10 to 74.5% by volume of the non-fluorine-containing chain carbonate (C2), based on the whole solvent (I).

It is preferable that a fluorine content of the fluorine-containing ether (A) represented by the above-mentioned formula (A) is 40 to 75% by mass, and in the formula (A), Rf¹ and Rf² are the same or different, Rf¹ is a fluorine-containing alkyl group having 3 or 4 carbon atoms, and Rf² is a fluorine-containing alkyl group having 2 or 3 carbon atoms.

It is preferable that a boiling point of the above-mentioned fluorine-containing ether (A) is 67° to 120° C.

It is preferable that the above-mentioned fluorine-containing ether (A) is at least one selected from the group consisting of HCF₂CF₂CH₂OCF₂CFHCF₃, CF₃CF₂CH₂OCF₂CFHCF₃, HCF₂CF₂CH₂OCF₂CF₂H and CF₃CF₂CH₂OCF₂CF₂H.

It is preferable that the above-mentioned non-fluorine-containing cyclic carbonate (C1) is at least one selected from the group consisting of ethylene carbonate, vinylene carbonate and propylene carbonate, and the non-fluorine-containing chain carbonate (C2) is at least one selected from the group consisting of dimethyl carbonate, diethyl carbonate and methyl ethyl carbonate.

It is preferable that in the above-mentioned electrolytic solution, (D) a phosphoric ester is contained in the solvent (I) for dissolving an electrolyte salt in an amount of 1 to 10% by volume.

It is preferable that the above-mentioned phosphoric ester (D) is (D1) a fluorine-containing alkyl phosphate.

It is preferable that the above-mentioned electrolytic solution comprises:

(E) at least one surfactant selected from the group consisting of (E1) fluorine-containing carboxylates represented by the formula (E1):

Rf⁷COO⁻M⁺

wherein Rf⁷ is a fluorine-containing alkyl group which has 3 to 12 carbon atoms and may have ether bond; M⁺ is Li⁺, Na⁺, K⁺ or NHR′₃⁺ (R′ are the same or different and each is H or an alkyl group having 1 to 3 carbon atoms), and
(E2) fluorine-containing sulfonates represented by the formula (E2):

Rf⁸SO₃⁻M⁺

wherein Rf⁸ is a fluorine-containing alkyl group which has 3 to 10 carbon atoms and may have ether bond; M⁺ is Li⁺, Na⁺, K⁺ or NHR′₃⁺ (R′ are the same or different and each is H or an alkyl group having 1 to 3 carbon atoms),
in an amount of 0.01 to 2% by mass based on the whole solvent (I) for dissolving an electrolyte salt.

The electrolytic solution of the present invention may comprise 1 to 30% by volume of a propionic acid ester. Also, the electrolytic solution of the present invention may comprise 0.1 to 5% by volume of an aromatic compound.

It is preferable that a concentration of the above-mentioned electrolyte salt (II) is 0.5 to 1.5 mole/liter.

It is preferable that the above-mentioned electrolyte salt (II) is LiPF₆ or LiBF₄.

It is preferable that the above-mentioned electrolyte salt (II) comprises (IIa) at least one electrolyte salt selected from the group consisting of LiN(SO₂CF₃)₂ and LiN(SO₂CF₂CF₃)₂.

It is preferable that the above-mentioned electrolyte salt (IIa) is LiN(SO₂CF₃)₂.

It is preferable that the above-mentioned electrolytic solution further comprises (IIb) at least one electrolyte salt selected from the group consisting of LiPF₆ and LiBF₄.

It is preferable that a concentration of the above-mentioned electrolyte salt (IIa) is 0.1 to 0.9 mole/liter, a concentration of the electrolyte salt (IIIb) is 0.1 to 0.9 mole/liter and a ratio of the concentration of the electrolyte salt (IIb)/the concentration of the electrolyte salt (IIa) is 1/9 to 9/1.

It is preferable that the above-mentioned electrolytic solution is used for a lithium ion secondary battery.

The present invention also relates to an electrochemical device provided with the above-mentioned electrolytic solution.

The present invention further relates to a lithium ion secondary battery provided with the above-mentioned electrolytic solution.

It is preferable that the above-mentioned lithium ion secondary battery is further provided with a positive electrode, a negative electrode and a separator.

It is preferable that an active material used on the above-mentioned positive electrode is at least one selected from the group consisting of cobalt compound oxides, nickel compound oxides, manganese compound oxides, iron compound oxides and vanadium compound oxides.

It is preferable that an active material used on the above-mentioned negative electrode is a carbon material.

In this specification, “flame retardancy” means a property of causing neither firing nor bursting in the flame retardancy test explained infra, and “noncombustibility” means a property of causing no ignition in the ignition test explained infra.

### BRIEF DESCRIPTION OF DRAWINGS

FIG. 1 is a longitudinal cross-sectional view of a double pole cell prepared in Test Example 8.

FIG. 2 is a graph (Cole-Cole-Plot) showing a change of internal impedance measured in Test Example 8.

FIG. 3 is a diagrammatic plan view of a laminated cell prepared in Test Example 9.

FIG. 4 is a graph showing a discharge curve measured in Test Example 9.

### BEST MODE FOR CARRYING OUT THE INVENTION

The electrolytic solution of the present invention is the electrolytic solution comprising the solvent (I) for dissolving an electrolyte salt having a specific composition and the electrolyte salt (II).

First, the solvent (I) for dissolving an electrolyte salt is explained below.

### (A) Fluorine-Containing Ether:

The fluorine-containing ether (A) is the fluorine-containing ether represented by the formula (A):

Rf¹—O—Rf²

wherein Rf¹ and Rf² are the same or different, Rf¹ is a fluorine-containing alkyl group having 3 to 6 carbon atoms, Rf² is a fluorine-containing alkyl group having 2 to 6 carbon atoms.

When the total number of carbon atoms of Rf¹ and Rf² is smaller than 5, a boiling point of the fluorine-containing ether becomes too low, and when the number of carbon atoms of Rf¹ and Rf² exceeds 6, solubility of the electrolyte salt is lowered and an adverse effect on compatibility with other solvents appears, and in addition, since viscosity is increased, rate characteristics (viscosity) are lowered. Especially the number of carbon atoms of Rf¹ of 3 or 4 and the number of carbon atoms of Rf² of 2 or 3 are advantageous from the viewpoint of a boiling point and good rate characteristics.

Also, since Rf¹ and Rf² have fluorine atoms, noncombustibility of the electrolytic solution of the present invention comprising this fluorine-containing ether (A) is improved.

Further preferably the fluorine content of fluorine-containing ether (A) is not less than 40% by mass, further preferably not less than 45% by mass, especially preferably not less than 50% by mass, and an upper limit of the fluorine content is preferably 75% by mass, further preferably 70% by mass. When the fluorine content is within this range, balance between noncombustibility and compatibility becomes especially satisfactory. In the present invention, the fluorine content is calculated by {(number of fluorine atoms×19)/molecular weight}×100(%).

Examples of Rf¹ are CF₃CF₂CH₂—, CF₃CFHCF₂—, HCF₂CF₂CF₂—, HCF₂CF₂CH₂—, CF₃CF₂CH₂CH₂—, CF₃CFHCF₂CH₂—, HCF₂CF₂CF₂CF₂—, HCF₂CF₂CF₂CH₂—, HCF₂CF₂CH₂CH₂—, and HCF₂CF(CF₃)CH₂—. Examples of Rf² are —CH₂CF₂CF₃, —CF₂CFHCF₃, —CF₂CF₂CF₂H, —CH₂CF₂CF₂H, —CH₂CH₂CF₂CF₃, —CH₂CF₂CFHCF₃, —CF₂CF₂CF₂CF₂H, —CH₂CF₂CF₂CF₂H, —CH₂CH₂CF₂CF₂H, —CH₂CF(CF₃)CF₂H, —CF₂CF₂H, —CH₂CF₂H, and —CF₂CH₃.

Particularly, Rf¹ and Rf² having HCF₂— or CF₃CFH— at one end or both ends thereof can provide the fluorine-containing ether being excellent in polarizability and having a high boiling point (not less than 67° C., further not less than 80° C., especially not less than 100° C.; an upper limit is 120° C.). Examples of suitable fluorine-containing ether are one or two or more of CF₃CH₂OCF₂CFHCF₃, CF₃CF₂CH₂OCF₂CFHCF₃, HCF₂CF₂CH₂OCF₂CFHCF₃, HCF₂CF₂CH₂OCH₂CF₂CF₂H, CF₃CFHCF₂CH₂OCF₂CFHCF₃, HCF₂CF₂CH₂OCF₂CF₂H, and CF₃CF₂CH₂OCF₂CF₂H. Particularly HCF₂CF₂CH₂OCF₂CFHCF₃ (boiling point: 106° C.), CF₃CF₂CH₂OCF₂CFHCF₃ (boiling point: 82° C.), HCF₂CF₂CH₂OCF₂CF₂H (boiling point: 88° C.) and CF₃CF₂CH₂OCF₂CF₂H (boiling point: 68° C.) are preferred, and HCF₂CF₂CH₂OCF₂CFHCF₃ (boiling point: 106° C.) and HCF₂CF₂CH₂OCF₂CF₂H (boiling point: 88° C.) are further preferred since they are advantageous from the viewpoint of high boiling point and good compatibility with other solvents and good solubility of the electrolyte salt.

The amount of fluorine-containing ether (A) is 20 to 60% by volume based on the whole solvent (I). When the amount is too large, solubility of the electrolyte salt is lowered and in some cases, phase separation is caused, and when the amount is too small, low temperature characteristics (stability at low temperatures) are lowered and flame retardancy is also lowered. In any of these cases, balance between liquid characteristics and battery characteristics is broken. A preferred upper limit is 50% by volume from the viewpoint of good compatibility with other solvents and good solubility of the electrolyte salt. The amount of not less than 20% by volume is preferred for maintaining low temperature characteristics and flame retardancy.

50% by volume or less of the fluorine-containing ether (A) may be replaced by other fluorine-containing ether.

### (B) Fluorine-Containing Solvent:

The fluorine-containing solvent (B) is at least one fluorine-containing solvent selected from the group consisting of the fluorine-containing cyclic carbonate (B1) and the fluorine-containing lactone (B2).

When the fluorine-containing cyclic carbonate (B1) is contained, an action of increasing dielectric constant and an effect of improving oxidation resistance and ionic conductivity can be obtained.

The fluorine-containing cyclic carbonate (B1) is represented by the formula (B1):

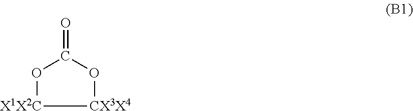

wherein X¹ to X⁴ are the same or different and each is —H, —F, —CF₃, —CF₂H, —CFH₂, —CF₂CF₃, —CH₂CF₃ or —CH₂OCH₂CF₂CF₃; at least one of X¹ to X⁴ is —F, —CF₃, —CF₂CF₃, —CH₂CF₃ or —CH₂OCH₂CF₂CF₃.

Each of X¹ to X⁴ is —H, —F, —CF₃, —CF₂H, —CFH₂, —CF₂CF₃, —CH₂CF₃ or —CH₂OCH₂CF₂CF₃, and —F, —CF₃, and —CH₂CF₃ are preferred from the viewpoint of good dielectric constant and viscosity and satisfactory compatibility with other solvents.

In the formula (B1), when at least one of X¹ to X⁴ is —F, —CF₃, —CF₂CF₃, —CH₂CF₃ or —CH₂OCH₂CF₂CF₃, only one of or some of X¹ to X⁴ may be replaced by —H, —F, —CF₃, —CF₂H, —CFH₂, —CF₂CF₃, —CH₂CF₃ or —CH₂OCH₂CF₂CF₃. Particularly preferably one or two of X¹ to X⁴ is replaced from the viewpoint of good dielectric constant and oxidation resistance.

The fluorine content of fluorine-containing cyclic carbonate (B1) is preferably 20 to 50% by mass, more preferably 30 to 50% by mass, from the viewpoint of satisfactory dielectric constant and oxidation resistance.

Among the fluorine-containing cyclic carbonates (B1), those mentioned below are preferred from the viewpoint that especially excellent characteristics such as high dielectric constant and high withstanding voltage are exhibited and solubility of an electrolyte salt and decrease in internal resistance are satisfactory, thereby improving characteristics of the lithium ion secondary battery of the present invention.

Examples of the fluorine-containing cyclic carbonate (B1) having high withstanding voltage and assuring good solubility of an electrolyte salt are, for instance,

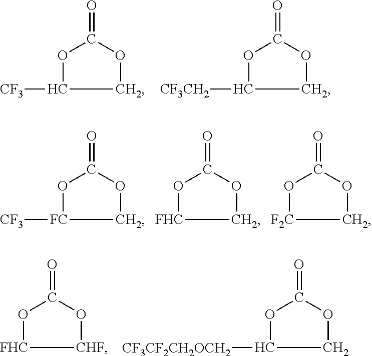

and the like.

Examples of other fluorine-containing cyclic carbonates (B1) which can be used are:

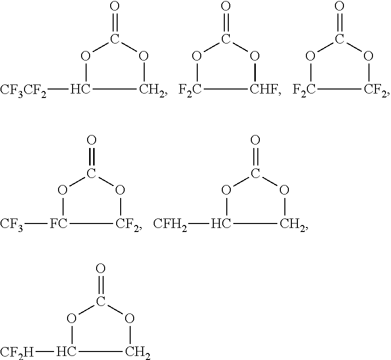

and the like.

When the fluorine-containing lactone (B2) is contained, an effect of improving ionic conductivity, safety and stability at high temperatures can be obtained.

Examples of the fluorine-containing lactone (B2) are, for instance, those represented by the formula (B2A):

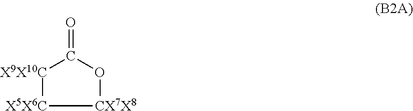

wherein X⁵ to X¹⁰ are the same or different and each is —H, —F, —Cl, —CH₃, or a fluorine-containing alkyl group; at least one of X⁵ to X¹⁰ is a fluorine-containing alkyl group.

Examples of the fluorine-containing alkyl group in X⁵ to X¹⁰ are —CFH₂, —CF₂H, —CF₃, —CH₂CF₃, —CF₂CF₃, —CH₂CF₂CF₃ and —CF(CF₃)₂ and from the viewpoint of high oxidation resistance and improvement in safety, —CH₂CF₃ and —CH₂CF₂CF₃ are preferred.

When at least one of X⁵ to X¹⁰ is a fluorine-containing alkyl group, only one of or some of X⁵ to X¹⁰ may be replaced by —H, —F, —Cl, —CH₃ or a fluorine-containing alkyl group. From the viewpoint of satisfactory solubility of an electrolyte salt, it is preferable that 1 to 3, especially 1 to 2 of them is replaced.

The position of substitution by a fluorine-containing alkyl group is not limited particularly, and from the viewpoint of good synthesis yield, it is preferable that X⁷ and/or X⁸, especially X⁷ or X⁸ is a fluorine-containing alkyl group, especially —CH₂CF₃ or —CH₂CF₂CF₃. In X⁵ to X¹⁰, a group other than a fluorine-containing alkyl group is —H, —F, —Cl or —CH₃, and from the viewpoint of satisfactory solubility of an electrolyte salt, —H is preferred.

Examples of the fluorine-containing lactone (B2) other than those represented by the above-mentioned formula (B2A) are, for instance, fluorine-containing lactones (B2) represented by the formula (B2B):

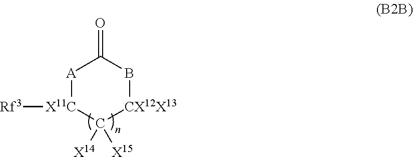

wherein either A or B is CX¹⁶X¹⁷ (X¹⁶ and X¹⁷ are the same or different and each is —H, —F, —CF₃, —CH₃, or an alkylene group in which hydrogen atom may be replaced by halogen atom and hetero atom may be contained in its chain), and another one is oxygen atom; Rf³ is a fluorine-containing alkyl group or a fluorine-containing alkoxy group which may have ether bond; X¹¹ and X¹² are the same or different and each is —H, —F, —Cl, —CF₃ or —CH₃; X¹³ to X¹⁵ are the same or different and each is —H, —F, —Cl or an alkyl group in which hydrogen atom may be replaced by halogen atom and hetero atom may be contained in its chain; n is 0 or 1.

Examples of preferred fluorine-containing lactones (B2) represented by the formula (B2B) are those having 5-membered ring structure represented by the formula (B2B-1):

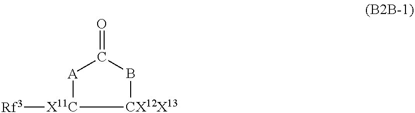

wherein A, B, Rf³, X¹¹, X¹² and X¹³ are as defined in the formula (B2B), from the viewpoint of easy synthesis and satisfactory chemical stability.

Depending on a combination of A and B, there are two fluorine-containing lactones (B2) represented by the formula (B2B-1), namely, one is a fluorine-containing lactone (B2) represented by the formula (B2B-1-1):

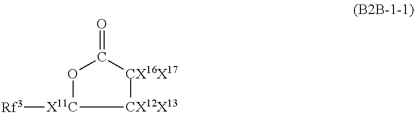

wherein Rf³, X¹¹, X¹², X¹³, X¹⁶ and X¹⁷ are as defined in the formula (B2B-1),
and another one is a fluorine-containing lactone (B2) represented by the formula (B2B-1-2):

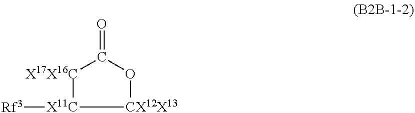

wherein Rf³, X¹¹, X¹², X¹³, X¹⁶ and X¹⁷ are as defined in the formula (B2B-1).

Among these, from the viewpoint that especially excellent characteristics such as high dielectric constant and high withstanding voltage can be exhibited and solubility of an electrolyte salt and decrease in internal resistance are satisfactory, thereby improving characteristics of the electrolytic solution in the present invention,

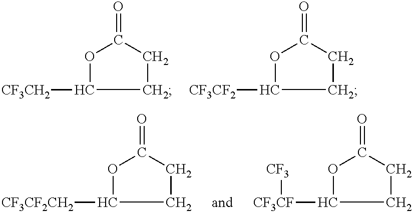

are preferred.

Examples of other fluorine-containing lactones (B2) which can be used are:

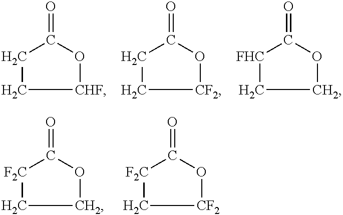

and the like.

The amount of fluorine-containing solvent (B) is 0.5 to 45% by volume based on the whole solvent (I). When the amount is too large, there are disadvantages that viscosity is increased, ionic conductivity is lowered and compatibility with a salt is lowered. A preferred upper limit is 40% by volume from the viewpoint of inhibiting such disadvantages while maintaining an effect of improving safety and compatibility.

The fluorine-containing solvent (B), especially the fluorine-containing cyclic carbonate (B1) has good solubility in the fluorine-containing ether (A) as compared with the non-fluorine-containing cyclic carbonate (C1) and is effective for improving oxidation resistance and increasing a flash point. When aiming to improve oxidation resistance and increase a flash point, the amount of fluorine-containing solvent (B) is preferably not less than 5% by volume, further preferably not less than 10% by volume.

Also, when aiming to increase a flash point, the total amount of fluorine-containing cyclic carbonate (B1), non-fluorine-containing cyclic carbonate (C1) and fluorine-containing ether (A) is preferably not less than 60% by volume, further preferably not less than 70% by volume based on the whole solvent (I).

### (C) Non-Fluorine-Containing Carbonate

The non-fluorine-containing carbonate (C) is at least one selected from the group consisting of the non-fluorine-containing cyclic carbonates (C1) and the non-fluorine-containing chain carbonates (C2).

Among the non-fluorine-containing cyclic carbonates (C1), ethylene carbonate (EC), vinylene carbonate (VC) and propylene carbonate (PC) are high in dielectric constant, are especially excellent in solubility of the electrolyte salt and are preferred for the electrolytic solution of the present invention. Also, in the case of using a graphite material on a negative electrode, a stable film can be formed on a negative electrode. In addition, butylene carbonate and vinyl ethylene carbonate can also be used.

The non-fluorine-containing chain carbonate (C2) is preferably a non-fluorine-containing chain carbonate being compatible with the fluorine-containing ether (A), the fluorine-containing solvent (B) and the non-fluorine-containing cyclic carbonates (C1) when (C1) is used together.

Examples of the non-fluorine-containing chain carbonate (C2) are one or two or more of hydrocarbon type chain carbonates such as CH₃CH₂OCOOCH₂CH₃ (diethyl carbonate; DEC), CH₃CH₂OCOOCH₃ (ethyl methyl carbonate; EMC), CH₃OCOOCH₃ (dimethyl carbonate; DMC), and CH₃OCOOCH₂CH₂CH₃ (methyl propyl carbonate). Among these, DEC, EMC and DMC are preferred from the viewpoint of high boiling point, low viscosity and especially excellent low temperature characteristics.

The amount of non-fluorine-containing cyclic carbonate (C1) is 5 to 40% by volume based on the whole solvent (I). In the solvent (I) system used in the present invention, when the amount of non-fluorine-containing cyclic carbonate (C1) is too large, phase separation of the fluorine-containing ether (A) occurs in low temperature atmosphere (for example, −30° C. to −20° C.), for example, at an outside air temperature in wintertime and at a temperature inside a refrigerator. From this point of view, a preferred upper limit is 35% by volume, further preferably 30% by volume. On the contrary, when the amount of non-fluorine-containing cyclic carbonate (C1) is too small, solubility of the electrolyte salt (II) in the solvent is lowered, and a desired electrolyte concentration (0.8 mole/liter or more) cannot be achieved.

The amount of non-fluorine-containing chain carbonate (C2) is preferably 10 to 74.5% by volume based on the whole solvent (I), and is preferably 20 to 74.5% by volume, more preferably 20 to 50% by volume from the viewpoint of good compatibility with other solvents and good solubility of the electrolyte salt.

The non-fluorine-containing chain carbonate (C2) provides an effect of improving rate characteristics and solubility, but as its amount increases, oxidation resistance is lowered and a flash point is decreased. Accordingly, when importance is placed on increase in a flash point and improvement in oxidation resistance, it is desirable that the amount of the non-fluorine-containing chain carbonate is not more than 40% by volume, further not more than 35% by volume based on the whole solvent (I).

When the non-fluorine-containing cyclic carbonate (C1) and the non-fluorine-containing chain carbonate (C2) are used together, it is preferable that the non-fluorine-containing cyclic carbonate (C1) is blended so that the total amount of non-fluorine-containing cyclic carbonate (C1) and fluorine-containing solvent (B) is the same as or smaller than the amount of non-fluorine-containing chain carbonate (C2). When the total amount of non-fluorine-containing cyclic carbonate (C1) and fluorine-containing solvent (B) is larger than the amount of non-fluorine-containing chain carbonate (C2), compatibility between the solvents tend to be lowered. When the non-fluorine-containing cyclic carbonate (C1) is blended so that the total amount of non-fluorine-containing cyclic carbonate (C1) and fluorine-containing solvent (B) is the same as or smaller than the amount of non-fluorine-containing chain carbonate (C2), a uniform electrolytic solution within a wide temperature range can be formed and cycle characteristics are improved.

### (D) Phosphoric Ester

The phosphoric ester (D) may be blended to impart noncombustibility (non-ignition property). Ignition can be prevented by mixing the phosphoric ester in an amount of 1 to 10% by volume in the solvent (I) for dissolving an electrolyte salt.

Examples of the phosphoric ester (D) are fluorine-containing alkylphosphoric ester (D1), non-fluorine-containing alkylphosphoric ester (D2) and arylphosphoric ester (D3), and fluorine-containing alkylphosphoric ester (D1) is preferred since it highly contributes to make the electrolytic solution nonflammable and an effect of making the electrolytic solution nonflammable is achieved even in a small amount.

Examples of the fluorine-containing alkylphosphoric ester (D1) are fluorine-containing dialkylphosphoric ester disclosed in JP11-233141A, cyclic alkylphosphoric ester disclosed in JP11-283669A, and fluorine-containing trialkylphosphoric ester (D1a) represented by the formula (D1a):

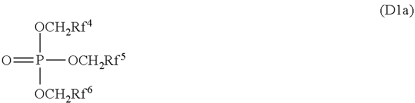

wherein Rf⁴, Rf⁵ and Rf⁶ are the same or different, and each is a fluorine-containing alkyl group having 1 to 3 carbon atoms.

Since the fluorine-containing trialkylphosphoric ester (D1a) has high capability of giving noncombustibility and satisfactory compatibility with the components (A), (B) and (C), its amount can be decreased, and even when its amount is 1 to 10% by volume, preferably 1 to 8% by volume, further 1 to 5% by volume, ignition can be prevented.

Preferable examples of the fluorine-containing trialkylphosphoric esters (D1a) are those, in which in the formula (D1a), Rf⁴, Rf⁵ and Rf⁶ are the same or different, and each is CF₃—, CF₃CF₂—, CF₃CH₂—, HCF₂CF₂— or CF₃CFHCF₂—. Especially, tri-2,2,3,3,3-pentafluoropropyl phosphate, in which any of Rf⁴, Rf⁵ and Rf⁶ are CF₃CF₂—, and tri-2,2,3,3-tetrafluoropropyl phosphate, in which any of Rf⁴, Rf⁵ and Rf⁶ are HCF₂CF₂—, are preferred.

### (E) Surfactant:

Surfactant (E) may be mixed to improve capacitive characteristics and rate characteristics.

With respect to the surfactant (E), any of a cationic surfactant, an anionic surfactant, a nonionic surfactant, and an amphoteric surfactant may be used, and from the viewpoint of satisfactory cycle characteristics and rate characteristics, fluorine-containing surfactants are preferred.

For example, there are preferably exemplified fluorine-containing carboxylates (E1) represented by the formula (E1):

Rf⁷COO⁻M⁺

wherein Rf⁷ is a fluorine-containing alkyl group which has 3 to 12 carbon atoms and may have ether bond; M⁺ is Li⁺, Na⁺, K⁺ or NHR′₃⁺ (R′ are the same or different and each is H or an alkyl group having 1 to 3 carbon atoms, and
fluorine-containing sulfonates (E2) represented by the formula (E2):

Rf⁸SO₃⁻M⁺

wherein Rf⁸ is a fluorine-containing alkyl group which has 3 to 10 carbon atoms and may have ether bond; M⁺ is Li⁺, Na⁺, K⁺ or NHR′₃⁺ (R′ are the same or different and each is H or an alkyl group having 1 to 3 carbon atoms.

Examples of the fluorine-containing carboxylates (E1) satisfying the formula (E1) are HCF₂C₂F₆COO⁻Li⁺, C₄F₉COO⁻Li⁺, C₅F₁₁COO⁻Li⁺, C₆F₁₃COO⁻Li⁺, C₇F₁₅COO⁻Li⁺, C₈F₁₇COO⁻Li⁺, HCF₂C₂F₆COO⁻NH₄⁺, C₄F₉COO⁻NH₄⁺, C₅F₁₁COO⁻NH₄⁺, C₆F₁₃COO⁻NH₄⁺, C₇F₁₅COO⁻NH₄⁺, C₈F₁₇COO⁻NH₄⁺, HCF₂C₂F₆COO⁻NH(CH₃)₃⁺, C₄F₉COO⁻NH(CH₃)₃⁺, C₅F₁₁COO⁻NH(CH₃)₃⁺, C₆F₁₃COO⁻NH(CH₃)₃⁺, C₇F₁₅COO⁻NH(CH₃)₃⁺, C₈F₁₇COO⁻NH(CH₃)₃⁺, CF₃O[CF(CF₃)CF₂O]ₙ—CF(CF₃)COOM, where M is Li, Na, K or NHR⁷₃ (R⁷ are the same or different and each is H or an alkyl group having 1 to 3 carbon atoms, n is 0 or an integer of 1 to 3), and the like. Examples of the fluorine-containing sulfonates (E2) satisfying the formula (E2) are C₄F₉SO₃⁻Li⁺, C₆F₁₃SO₃Li⁺, C₈F₁₇SO₃⁻Li⁺, C₄F₉SO₃⁻NH₄⁺, C₆F₁₃SO₃⁻NH₄⁺, C₈F₁₇SO₃⁻NH₄⁺, C₄F₉SO₃⁻NH(CH₃)₃⁺, C₆F₁₃SO₃⁻NH(CH₃)₃⁺, C₈F₁₇SO₃⁻NH(CH₃)₃⁺, and the like.

The amount of the surfactant (E) is preferably 0.01 to 2% by mass based on the whole solvent (I) for dissolving an electrolyte salt from the viewpoint of decreasing a surface tension of the electrolytic solution without lowering charge-discharge cycle characteristics.

(F) Fluorine-Containing Chain Carbonate being Compatible with the Fluorine-Containing Ether (A), the Fluorine-Containing Solvent (B) and the Non-Fluorine-Containing Carbonate (C):

Fluorine-containing chain carbonate (F) being compatible with the fluorine-containing ether (A), the fluorine-containing solvent (B) and the non-fluorine-containing carbonate (C) may be mixed in the case of low compatibility of the fluorine-containing ether (A) with the fluorine-containing solvent (B) and low compatibility of the fluorine-containing ether (A) with the non-fluorine-containing carbonate (C) and in the case of insufficient stability.

Examples of the fluorine-containing chain carbonate (F) are one or two or more of fluorine-containing hydrocarbon type chain carbonates such as CF₃CH₂OCOOCH₂CF₃, CF₃CH₂OCOOCH₃, CF₃CF₂CH₂OCOOCH₃ and HCF₂CF₂CH₂OCOOCH₃. From the viewpoint of a high boiling point, low viscosity and satisfactory low temperature characteristics, CF₃CH₂OCOOCH₂CF₃, CF₃CH₂OCOOCH₃, CF₃CF₂CH₂OCOOCH₃ and HCF₂CF₂CH₂OCOOCH₃ are preferred.

The amount of fluorine-containing chain carbonate (F) is preferably 20 to 74.5% by volume based on the whole solvent (I), and is more preferably 20 to 50% by volume from the viewpoint of satisfactory compatibility with other solvents and solubility of the electrolyte salt.

### (G) Other Additives

In the present invention, other additives such as an additive for increasing dielectric constant, cycle characteristics and rate characteristics improver and an over-charging inhibitor may be mixed to an extent not to deviate from the specified volume percentages of the components (A), (B), (C) and if necessary, (D), (E) and (F) and also not to impair the effect of the present invention.

Examples of an additive for increasing dielectric constant are sulfolane, methyl sulfolane, γ-butyrolactone, γ-valerolactone, acetonitrile and propionitrile.

Examples of an over-charging inhibitor are, for instance, aromatic compounds such as hexafluorobenzene, fluorobenzene, cyclohexylbenzene, dichloroaniline and toluene. The amount of aromatic compound is about 0.1 to 5% by volume based on the whole solvent (I).

Examples of a cycle characteristics and rate characteristics improver are methyl acetate, ethyl acetate, tetrahydrofuran, 1,4-dioxane, and in addition, propionic esters such as methyl propionate, ethyl propionate and propyl propionate. The amount of propionic ester is about 1 to 30% by volume based on the whole solvent (I).

For improving capacitive characteristics and rate characteristics, fluorine-containing esters such as HCF₂COOCH₃, HCF₂COOC₂H₅, CF₃COOCH₃, CF₃COOC₂H₅, C₂F₅COOCH₃ and HCF₂CF₂COOCH₃ are preferred.

In addition, flame retardants such as (CH₃O)₃P═O and (CF₃CH₂O)₃P═O can be added for the purpose of improving flame retardancy.

The solvent (I) for dissolving an electrolyte salt can be prepared by mixing the components (A), (B), (C) and further, as case demands, the components (D), (E), (F) and (G) and uniformly dissolving them.

Next, the electrolyte salt (II) is explained below.

In order to secure practical performance of the lithium ion secondary battery, the concentration of the electrolyte salt is required to be not less than 0.5 mole/liter, further not less than 0.8 mole/liter. An upper limit is usually 1.5 mole/liter. The solvent (I) for dissolving an electrolyte salt which is used in the present invention has ability of dissolving the electrolyte salt (II) at the concentration satisfying the requirements mentioned above.

The electrolyte salt (II) to be used for the electrolytic solution of the present invention in the first embodiment is LiPF₆ or LiBF₄ which is used on many lithium ion secondary batteries.

Then, the electrolyte salt (II) to be used for the electrolytic solution of the present invention in the second embodiment is at least one electrolyte salt (IIa) selected from the group consisting of LiN(SO₂CF₃)₂ and LiN(SO₂CF₂CF₃)₂.

The electrolyte salt (IIa) is excellent in dissociation property, especially solubility in the fluorine-containing ether (A), and its concentration in the electrolytic solution is not less than 0.1 mole/liter. When this electrolyte salt (IIa) is contained, ionic conductivity of the electrolytic solution can be improved. An upper limit of the concentration is usually 0.9 mole/liter.

In the present invention, the electrolyte salt (IIa) may be blended alone, and when it is used together with an electrolyte salt (IIIb) selected from LiPF₆ and LiBF₄, further, an effect of preventing corrosion of an aluminum current collector and metal of cell material can be obtained. In the case of using the both together, the concentration of the electrolyte salt (IIb) is not less than 0.1 mole/liter. An upper limit thereof is usually 0.9 mole/liter.

Further, in the case of using the both together, it is preferable that the concentration of the electrolyte salt (IIa) is 0.1 to 0.9 mole/liter, the concentration of the electrolyte salt (IIb) is 0.1 to 0.9 mole/liter, and a ratio of the concentration of the electrolyte salt (IIb) to (the concentration of the electrolyte salt (IIa)) is 1/9 to 9/1, from the viewpoint of improvement in cycle characteristics and coulomb efficiency and satisfactory ionic conductivity, resulting from the prevention of corrosion of metal.

Next, preferable formulations of the electrolytic solution of the present invention are mentioned below, but the present invention is not limited thereto.

(Formulation a1)
(I) Solvent for dissolving an electrolyte salt
(A) Fluorine-containing ether
Kind: HCF₂CF₂CH₂OCF₂CFHCF₃
Amount: 20 to 50% by volume (amount in the solvent (I), hereinafter the same)
   (B) Fluorine-containing solvent
Kind: Fluorine-containing cyclic carbonate

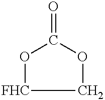

Amount: 1 to 5% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate, ethyl methyl carbonate or dimethyl carbonate
Amount: 20 to 60% by volume
   (D) Phosphoric ester
Kind: Fluorine-containing alkylphosphoric ester
Amount: 1 to 5% by volume
   (II) Electrolyte salt
Kind: LiPF₆ or LiBF₄
Concentration: 0.9 to 1.2 mole/liter
   (Formulation a2)
   (I) Solvent for dissolving an electrolyte salt
   (A) Fluorine-containing ether
Kind: HCF₂CF₂CH₂OCF₂CFHCF₃
Amount: 20 to 50% by volume (amount in the solvent (I), hereinafter the same)
   (B) Fluorine-containing solvent
Kind: Fluorine-containing lactone

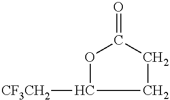

Amount: 2 to 10% by volume
   (C1) Non-fluorine-containing cyclic carbonate
Kind: Ethylene carbonate, vinylene carbonate or propylene carbonate
Amount: 10 to 30% by volume
   (C2) Non-fluorine-containing chain carbonate
Kind: Diethyl carbonate, ethyl methyl carbonate or dimethyl carbonate
Amount: 10 to 47% by volume
   (D) Phosphoric ester
Kind: Fluorine-containing alkylphosphoric ester
Amount: 1 to 5% by volume
   (II) Electrolyte salt
Kind: LiPF₆ or LiBF₄
Concentration: 0.9 to 1.2 mole/liter
   (Formulation a3)
   (I) Solvent for dissolving an electrolyte salt
   (A) Fluorine-containing ether
Kind: HCF₂CF₂CH₂OCF₂CF₂H
Amount: 20 to 50% by volume (amount in the solvent (I), hereinafter the same)
   (B) Fluorine-containing solvent
Kind: Fluorine-containing cyclic carbonate

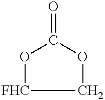

Amount: 1 to 5% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate, ethyl methyl carbonate or dimethyl carbonate
Amount: 20 to 60% by volume
   (D) Phosphoric ester
Kind: Fluorine-containing alkylphosphoric ester
Amount: 1 to 5% by volume
   (II) Electrolyte salt
Kind: LiPF₆ or LiBF₄
Concentration: 0.9 to 1.2 mole/liter
   (Formulation a4)
   (I) Solvent for dissolving an electrolyte salt
   (A) Fluorine-containing ether
Kind: HCF₂CF₂CH₂OCF₂CF₂H
Amount: 20 to 50% by volume (amount in the solvent (I), hereinafter the same)
   (B) Fluorine-containing solvent
Kind: Fluorine-containing cyclic carbonate

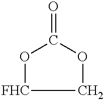

Amount: 5 to 35% by volume
   (C1) Non-fluorine-containing cyclic carbonate
Kind: Ethylene carbonate, vinylene carbonate or propylene carbonate
Amount: 0 to 25% by volume
   (C2) Non-fluorine-containing chain carbonate
Kind: Diethyl carbonate, ethyl methyl carbonate or dimethyl carbonate
Amount: 5 to 40% by volume
   (D) Phosphoric ester
Kind: Fluorine-containing alkylphosphoric ester
Amount: 1 to 5% by volume
   (II) Electrolyte salt
Kind: LiPF₆ or LiBF₄
Concentration: 0.9 to 1.2 mole/liter
   (Formulation a5)
   (I) Solvent for dissolving an electrolyte salt
   (A) Fluorine-containing ether
Kind: HCF₂CF₂CH₂OCF₂CF₂H
Amount: 20 to 50% by volume (amount in the solvent (I), hereinafter the same)
   (B) Fluorine-containing solvent
Kind: Fluorine-containing lactone

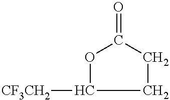

Amount: 2 to 10% by volume
   (C1) Non-fluorine-containing cyclic carbonate
Kind: Ethylene carbonate, vinylene carbonate or propylene carbonate
Amount: 10 to 30% by volume
   (C2) Non-fluorine-containing chain carbonate
Kind: Diethyl carbonate, ethyl methyl carbonate or dimethyl carbonate
Amount: 10 to 47% by volume
   (D) Phosphoric ester
Kind: Fluorine-containing alkylphosphoric ester
Amount: 1 to 5% by volume
   (II) Electrolyte salt
Kind: LiPF₆ or LiBF₄
Concentration: 0.9 to 1.2 mole/liter
   (Formulation b1)
   (I) Solvent for dissolving an electrolyte salt
   (A) Fluorine-containing ether
Kind: HCF₂CF₂CH₂OCF₂CFHCF₃
Amount: 20 to 50% by volume (amount in the solvent (I), hereinafter the same)
   (B) Fluorine-containing solvent
Kind: Fluorine-containing cyclic carbonate

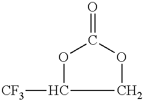

Amount: 3 to 10% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate, ethyl methyl carbonate or dimethyl carbonate
Amount: 25 to 62% by volume
   (D) Phosphoric ester
Kind: Fluorine-containing alkylphosphoric ester
Amount: 1 to 5% by volume
   (II) Electrolyte salt
Electrolyte salt (II-1)
   Kind: LiN(SO₂CF₃)₂ or LiN(SO₂CF₂CF₃)₂
   Concentration: 0.9 to 1.2 mole/liter
      (Formulation b2)
      (I) Solvent for dissolving an electrolyte salt
      (A) Fluorine-containing ether
Kind: HCF₂CF₂CH₂OCF₂CFHCF₃
Amount: 20 to 50% by volume (amount in the solvent (I), hereinafter the same)
   (B) Fluorine-containing solvent
Kind: Fluorine-containing lactone

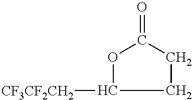

Amount: 1 to 10% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate or ethyl methyl carbonate
Amount: 10 to 63% by volume
   (D) Phosphoric ester
Kind: Fluorine-containing alkylphosphoric ester
Amount: 1 to 5% by volume
   (II) Electrolyte salt
Electrolyte salt (IIa)
   Kind: LiN(SO₂CF₃)₂ or LiN(SO₂CF₂CF₃)₂
   Concentration: 0.9 to 1.2 mole/liter
      (Formulation b3)
      (I) Solvent for dissolving an electrolyte salt
      (A) Fluorine-containing ether
Kind: HCF₂CF₂CH₂OCF₂CF₂H
Amount: 20 to 50% by volume (amount in the solvent (I), hereinafter the same)
   (B) Fluorine-containing solvent
Kind: Fluorine-containing cyclic carbonate

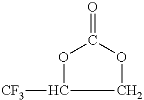

Amount: 3 to 10% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate, ethyl methyl carbonate or dimethyl carbonate
Amount: 25 to 62% by volume
   (D) Phosphoric ester
Kind: Fluorine-containing alkylphosphoric ester
Amount: 1 to 5% by volume
   (II) Electrolyte salt
Electrolyte salt (II-1)
   Kind: LiN(SO₂CF₃)₂ or LiN(SO₂CF₂CF₃)₂
   Concentration: 0.9 to 1.2 mole/liter
      (Formulation b4)
      (I) Solvent for dissolving an electrolyte salt
      (A) Fluorine-containing ether
Kind: HCF₂CF₂CH₂OCF₂CF₂H
Amount: 20 to 50% by volume (amount in the solvent (I), hereinafter the same)
   (B) Fluorine-containing solvent
Kind: Fluorine-containing lactone

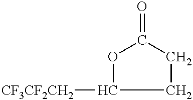

Amount: 1 to 10% by volume
   (C1) Non-fluorine-containing cyclic carbonate
Kind: Ethylene carbonate, vinylene carbonate or propylene carbonate
Amount: 5 to 25% by volume
   (C2) Non-fluorine-containing chain carbonate
Kind: Diethyl carbonate or ethyl methyl carbonate
Amount: 10 to 63% by volume
   (D) Phosphoric ester
Kind: Fluorine-containing alkylphosphoric ester
Amount: 1 to 5% by volume
   (II) Electrolyte salt
Electrolyte salt (IIa)
   Kind: LiN(SO₂CF₃)₂ or LiN(SO₂CF₂CF₃)₂
   Concentration: 0.9 to 1.2 mole/liter

The electrolytic solution of the present invention as explained above can be used on electrolytic capacitor, electrical double layer capacitor, cells undergoing charge/discharge due to charge-transfer of ion, solid display devices such as electroluminescent device and sensors such as a current sensor and a gas sensor.

Of these applications, the electrolytic solution of the present invention is suitable for lithium ion secondary batteries provided with a positive electrode, a negative electrode, a separator and the electrolytic solution of the present invention, and especially it is preferable that an active material of a positive electrode is at least one selected from the group consisting of cobalt compound oxides, nickel compound oxides, manganese compound oxides, iron compound oxides and vanadium compound oxides because secondary batteries exhibit high energy density and high output.

Example of cobalt compound oxide is LiCoO₂, example of nickel compound oxide is LiNiO₂, and example of manganese compound oxide is LiMnO₂. Also, compound oxides of CoNi represented by LiCoₓNi₁₋ₓO₂ (0<x<1), compound oxides of CoMn represented by LiCoₓMn₁₋ₓO₂ (0<x<1), compound oxides of NiMn represented by LiNiₓMn₁₋ₓO₂ (0<x<1) and LiNiₓMn₂₋ₓO₄ (0<x<2), and compound oxides of NiCoMn represented by LiNi_{1-x-y}CoₓMn_{y}O₂ (0<x<1, 0<y<1, 0<x+y<1) may be used. In these lithium-containing compound oxides, a part of metal elements such as Co, Ni and Mn may be replaced by at least one metal element such as Mg, Al, Zr, Ti and Cr.

Examples of iron compound oxide are LiFeO₂ and LiFePO₄, and example of vanadium compound oxide is V₂O₅.

Of the above-mentioned compound oxides, nickel compound oxides and cobalt compound oxides are preferred as an active material of a positive electrode because battery capacity can be increased. Especially in the case of small size lithium ion secondary batteries, it is desirable to use cobalt compound oxides from the viewpoint of high energy density and safety.

In the present invention, especially for the uses on large size lithium ion secondary batteries for hybrid cars and distributed power source, since high output is demanded, it is preferable that particles of an active material for a positive electrode mainly comprise secondary particles, and an average particle size of secondary particles is not more than 40 μm and fine particles having an average primary particle size of not more than 1 μm are contained in an amount of 0.5 to 7.0% by volume.

When fine particles having an average primary particle size of not more than 1 μm are contained, an area thereof coming into contact with an electrolytic solution is increased and lithium ion can be scattered more rapidly between the electrode and the electrolytic solution, thereby enabling output performance to be improved.

In the present invention, examples of an active material to be used on a negative electrode are carbon materials, and in addition, metallic oxides and metallic nitrides to which lithium ion can be inserted. Examples of carbon materials are natural graphite, artificial graphite, pyrocarbon, coke, mesocarbon microbeads, carbon fiber, activated carbon and pitch-coated graphite. Examples of metallic oxides to which lithium ion can be inserted are tin- or silicon-containing metallic compounds, for example, tin oxide and silicon oxide, and examples of metallic nitrides are Li_{2.6}Co_{0.4}N, etc.

A separator which can be used in the present invention is not limited particularly, and examples thereof are microporous polyethylene film, microporous polypropylene film, microporous ethylene-propylene copolymer film, microporous polypropylene/polyethylene two-layered film, microporous polypropylene/polyethylene/polypropylene three-layered film, etc.

The electrolytic solution of the present invention is nonflammable, and therefore, is useful especially as an electrolytic solution for the above-mentioned large size lithium ion secondary batteries for hybrid cars and distributed power source, and in addition, is useful as a non-aqueous electrolytic solution for small size lithium ion secondary batteries.

### EXAMPLE

The present invention is then explained by means of examples, but the present invention is not limited to them.

Compounds used in the following examples and comparative examples are as follows.

### Component (A)

(A1): HCF₂CF₂CH₂OCF₂CFHCF₃

(A2): C₂F₅CH₂OCF₂CFHCF₃

(A3): HCF₂CF₂CH₂OCF₂CF₂H

(A4): CF₃CF₂CH₂OCF₂CF₂H

### Component (B)

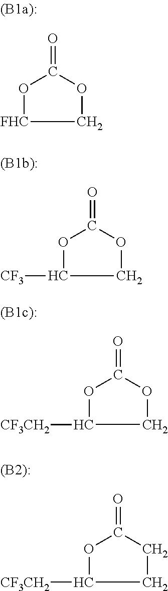

### Component (C1)

(C1a): Ethylene carbonate (EC)

(C1b): Vinylene carbonate (VC)

(C1c): Propylene carbonate (PC)

### Component (C2)

(C2a): Dimethyl carbonate (DMC)

(C2b): Diethyl carbonate (DEC)

(C2c): Ethyl methyl carbonate (EMC)

### Component (D)

(D1): Tri-2,2,3,3,3-pentafluoropropyl phosphate

(D2): Trimethyl phosphate

### Component (E)

(E1a): C₅F₁₁COO⁻Li⁺

(E1b): C₃F₇OC(CF₃)FCF₂OC(CF₃)FCOO⁻Li⁺

### Component (G)

(G1): (CH₃O)₃P═O

(G2): (CF₃CH₂O)₃P═O

(G3): Ethyl propionate

(G4): Propyl propionate

(G5): Fluorobenzene

### Electrolyte Salt (II)

(IIa): LiN(SO₂CF₃)₂

(IIb): LiPF₆

### Example 1

A solvent for dissolving an electrolyte salt was prepared by mixing Component (A), Component (B), Component (C1) and Component (C2) in a volume percent ratio of 40/5/10/45, and to this solvent for dissolving an electrolyte salt was added Component (IIb) to give a concentration of 1 mole/liter, followed by sufficiently stirring at 25° C. to prepare the electrolytic solution of the present invention.

### Examples 2 to 35

Electrolytic solutions of the present invention were prepared in the same manner as in Example 1 except that the Components (A) to (G) and the electrolyte salt (II) were changed to those shown in Tables 1 to 5.

### Comparative Example 1

A comparative electrolytic solution was prepared in the same manner as in Example 1 except that Components (A) to (G) and the electrolyte salt (II) were changed to those shown in Table 1.

### Test Example 1

### Solubility of Electrolyte Salt

6 ml each of the electrolytic solutions prepared in Examples 1 to 25 and Comparative Example 1 was poured in a 9 ml sample bottle and allowed to stand at 25° C. for eight hours. Then, a state of the solutions was observed with naked eyes. The results are shown in Tables 1 to 3.

### (Criteria for Evaluation)

◯: Solution is uniform.
Δ: Electrolyte salt is precipitated.
x: Solution undergoes phase separation.

### Test Example 2

### Stability at Low Temperature

6 ml each of the electrolytic solutions prepared in Examples 1 to 25 and Comparative Example 1 was poured in a 9 ml sample bottle and allowed to stand in a refrigerator of −20° C. for eight hours. Then, a state of the solutions was observed with naked eyes. The results are shown in Tables 1 to 3.

### (Criteria for Evaluation)

◯: Solution is uniform.
Δ: Electrolyte salt is precipitated.
x: Solution undergoes solidification.

TABLE 1

| | Example | | | | | | | | | | Com. Ex. |
|---|---|---|---|---|---|---|---|---|---|---|---|
| | 1 | 2 | 3 | 4 | 5 | 6 | 7 | 8 | 9 | 10 | 1 |
| Electrolytic solution | | | | | | | | | | | |
| Solvent components | | | | | | | | | | | |
| Component (A) | | | | | | | | | | | |
| Kind | A1 | A1 | A1 | A2 | A2 | A2 | A1 | A1 | A1 | A1 | — |
| Content (volume %) | 40 | 30 | 50 | 30 | 40 | 50 | 40 | 40 | 40 | 40 | — |
| Component (B) | | | | | | | | | | | |
| Kind | B1a | B1a | B1a | B1a | B1a | B1a | B1a | B1b | B1a | B1c | — |
| Content (volume %) | 5 | 5 | 5 | 5 | 5 | 5 | 5 | 5 | 5 | 10 | — |
| Component (C1) | | | | | | | | | | | |
| Kind | C1a | C1a | C1a | C1a | C1a | C1a | C1a | C1a | C1a | C1a | C1a |
| Content (volume %) | 10 | 10 | 10 | 10 | 10 | 10 | 10 | 10 | 10 | 10 | 30 |
| Component (C2) | | | | | | | | | | | |
| Kind | C2a | C2a | C2a | C2a | C2a | C2a | C2a | C2a | C2a | C2a | C2a |
| Content (volume %) | 45 | 55 | 35 | 55 | 45 | 35 | 35 | 40 | 35 | 40 | 70 |
| Component (D) | | | | | | | | | | | |
| Kind | — | — | — | — | — | — | D1 | D1 | D2 | D2 | — |
| Content (volume %) | — | — | — | — | — | — | 10 | 10 | 10 | 10 | — |
| Electrolyte salt | | | | | | | | | | | |
| (concentration: mole/liter) | | | | | | | | | | | |
| IIa | — | — | — | — | — | — | — | — | — | — | — |
| IIb | 1 | 1 | 1 | 1 | 1 | 1 | 1 | 1 | 1 | 1 | 1 |
| 1: Solubility | ◯ | ◯ | ◯ | ◯ | ◯ | ◯ | ◯ | ◯ | ◯ | ◯ | ◯ |
| 2: Stability at low temperature | ◯ | ◯ | ◯ | ◯ | ◯ | ◯ | ◯ | ◯ | ◯ | ◯ | ◯ |

TABLE 2

| | Example | | | | | | | |
|---|---|---|---|---|---|---|---|---|
| | 11 | 12 | 13 | 14 | 15 | 16 | 17 | 18 |
| Electrolytic solution | | | | | | | | |
| Solvent components | | | | | | | | |
| Component (A) | | | | | | | | |
| Kind | A1 | A1 | A1 | A2 | A2 | A2 | A2 | A2 |
| Content (volume %) | 40 | 40 | 40 | 40 | 40 | 40 | 40 | 40 |
| Component (B) | | | | | | | | |
| Kind | B1a | B1a | B1a | B1a | B1a | B1a | B1a | B1c |
| Content (volume %) | 5 | 5 | 5 | 5 | 5 | 3 | 5 | 5 |
| Component (C1) | | | | | | | | |
| Kind | C1a | C1a + C1c | C1a + C1c | C1a + C1c | C1a + C1c | C1a + C1c | C1a + C1c | C1a + C1c |
| Content (volume %) | 10 | 10 + 10 | 10 + 10 | 10 + 10 | 10 + 10 | 12 + 10 | 10 + 10 | 10 + 10 |
| Component (C2) | | | | | | | | |
| Kind | C2a | C2a | C2a | C2a | C2a | C2a | C2a | C2a |
| Content (volume %) | 35 | 35 | 30 | 35 | 30 | 35 | 30 | 30 |
| Component (D) | | | | | | | | |
| Kind | D2 | — | D2 | — | D1 | — | D1 | D2 |
| Content (volume %) | 10 | — | 5 | — | 5 | — | 5 | 5 |
| Electrolyte salt | | | | | | | | |
| (concentration: mole/liter) | | | | | | | | |
| IIa | 1 | — | — | — | — | — | — | — |
| IIb | — | 1 | 1 | 1 | 1 | 1 | 1 | 1 |
| 1: Solubility | ◯ | ◯ | ◯ | ◯ | ◯ | ◯ | ◯ | ◯ |
| 2: Stability at low temperature | ◯ | ◯ | ◯ | ◯ | ◯ | ◯ | ◯ | ◯ |

TABLE 3

| | Example | | | | | | |
|---|---|---|---|---|---|---|---|
| | 19 | 20 | 21 | 22 | 23 | 24 | 25 |
| Electrolytic solution | | | | | | | |
| Solvent components | | | | | | | |
| Component (A) | | | | | | | |
| Kind | A2 | A2 | A2 | A2 | A2 | A2 | A2 |
| Content (volume %) | 40 | 40 | 40 | 40 | 40 | 40 | 40 |
| Component (B) | | | | | | | |
| Kind | B1a | B1a | B1a | B1a | B1a | B1b | B1a + B1b |
| Content (volume %) | 5 | 3 | 3 | 3 | 3 | 5 | 3 + 5 |
| Component (C1) | | | | | | | |
| Kind | C1a + C1c | C1a + C1c | C1a + C1c | C1a + C1c | C1a + C1c | C1a + C1c | C1a + C1c |
| Content (volume %) | 10 + 10 | 12 + 10 | 12 + 10 | 12 + 10 | 12 + 10 | 10 + 10 | 10 + 10 |
| Component (C2) | | | | | | | |
| Kind | C2a | C2a | C2a | C2a | C2a | C2a | C2a |
| Content (volume %) | 35 | 35 | 32 | 32 | 27 | 35 | 32 |
| Component (D) | | | | | | | |
| Kind | — | — | — | — | D1 | — | — |
| Content (volume %) | — | — | — | — | 5 | — | — |
| Component (G) | | | | | | | |
| Kind | — | — | G1 | G2 | G1 | — | — |
| Content (volume %) | — | — | 3 | 3 | 3 | — | — |
| Electrolyte salt | | | | | | | |
| (concentration: mole/liter) | | | | | | | |
| IIa | 1 | 0.3 | — | — | — | — | — |
| IIb | — | 0.7 | 1 | 1 | 1 | 1 | 1 |
| 1: Solubility of electrolyte salt | ◯ | ◯ | ◯ | ◯ | ◯ | ◯ | ◯ |
| 2: Stability at low temperature | ◯ | ◯ | ◯ | ◯ | ◯ | ◯ | ◯ |

### Test Example 3

### Charge-Discharge Characteristics

### <Preparation of Positive Electrode>

An active material of a positive electrode prepared by mixing LiCoO₂, carbon black and polyvinylidene fluoride (trade name KF-1000 available from KUREHA CORPORATION) in a ratio of 85/6/9 (in mass percent ratio) was dispersed in N-methyl-2-pyrrolidone to be formed into a slurry, and the slurry was coated uniformly on a current collector for a positive electrode (20 μm thick aluminum foil). After drying, the coated current collector was punched into a disc of 12.5 mm diameter to make a positive electrode.

### <Preparation of Negative Electrode>

A styrene-butadiene rubber dispersed in distilled water was added to artificial graphite powder (trade name KS-44 available from TIMCAL) to give a solid content of 6% by mass, and then was mixed with a disperser to be formed into a slurry. The mixture in the form of slurry was uniformly coated on a current collector for a negative electrode (18 μm thick aluminum foil). After drying, the coated current collector was punched into a disc of 12.5 mm diameter to make a negative electrode.

### <Preparation of Separator>

Polyethylene separators (trade name Celgard 3501 available from Celgard Co., Ltd.) having a diameter of 14 mm were impregnated with the electrolytic solutions prepared in Examples 1 to 25 and Comparative Example 1 to prepare separators.

### <Preparation of Coin Type Lithium Secondary Battery>

The above-mentioned positive electrode was put in a stainless steel can which doubled as a current collector for a positive electrode, and then the above-mentioned negative electrode was put thereon with the separator being placed between them. Caulking of this can and a sealing sheet which doubled as a current collector for a negative electrode was carried out for sealing with an insulating gasket being placed between them to make a coin type lithium secondary battery.

### <Charge and Discharge Test>

Discharge capacity after 50 cycles was measured under the following charge and discharge measuring conditions. The result of evaluation is indicated by an index assuming the result of Comparative Example 1 to be 100. The results are shown in Table 4.

Charge and discharge voltage: 2.5 to 4.2 V
Charging: A constant voltage is maintained at 0.5 C at 4.2 V until a charge current reaches 1/10.

### Discharging: 1 C

### Test Example 4

### Flame Retardancy Test

Flame retardancy of the electrolytic solutions prepared in Examples 1 to 25 and Comparative Example 1 was Examined by the following methods. The results are shown in Table 4.

### <Preparation of Sample>

A positive electrode and a negative electrode prepared in the same manner as in Test Example 3 were cut into rectangular pieces of 50 mm×100 mm, and a polyethylene separator (trade name Celgard 3501 available from Celgard Co., Ltd.) was sandwiched between these electrodes to make a laminated article. After welding a 5 mm wide×150 mm long aluminum foil as a lead wire to the positive electrode and the negative electrode, this laminated article was dipped in the electrolytic solutions prepared in the above-mentioned Examples and Comparative Example, followed by sealing with a laminator to prepare laminated cells.

### <Test Method>

The following three flame retardancy tests were carried out by using the laminated cells.

### [Nail Piercing Test]

After charging the laminated cell up to 4.3 V, a nail of 3 mm diameter is pierced through the laminated cell, and whether firing or bursting of the laminated cell occurs is examined. When no firing (bursting) occurs, it is shown by ◯, and when firing (bursting) occurs, it is shown by x.

### [Over-Charge Test]

The laminated cell is charged for 24 hours at 10 hour rate, and whether firing of the laminated cell occurs is examined. When no firing (bursting) occurs, it is shown by ◯, and when firing (bursting) occurs, it is shown by x.

### [Short-Circuit Test]

After charging the laminated cell up to 4.3 V, the positive electrode and the negative electrode are subjected to short-circuit with a copper wire to check to see if firing of the laminated cell occurs. When no firing (bursting) occurs, it is shown by ◯, and when firing (bursting) occurs, it is shown by x.

### Test Example 5

### Ignition Test

Noncombustibility (non-ignition property) of the electrolytic solutions prepared in Examples 1 to 25 and Comparative Example 1 was examined by the following methods. The results are shown in Table 4.

### <Preparation of Sample>

A strip of cellulose paper (15 mm wide×320 mm long×0.04 mm thick) was fully dipped in the electrolytic solutions prepared in Examples 1 to 25 and Comparative Example 1, and then taken out to make a sample.

### <Test Method>

The sample is fixed on a metallic stand, and a flame of a lighter is set near one end of the sample and kept as it is for one second to check to see whether or not ignition occurs.

### Test Example 6

### Charge-Discharge Characteristics

Slurry of a positive electrode and slurry of a negative electrode were prepared in the same manner as in Test Example 3, and coated on an aluminum foil with a blade coater in a thickness of 50 μm. After fitting a lead to these positive electrode and negative electrode, respectively, a separator was sandwiched between the electrodes, and these were wound and put in a SUS304 stainless steel outer can, followed by vacuum impregnation with an electrolytic solution and then sealing to prepare a cylindrical cell having a diameter of 18 mm and a height of 50 mm. A safety device such as a safety valve was not used in order to clarify a difference in safety. Then, discharge capacity after 50 cycles was measured under the following charge and discharge measuring conditions. The result of evaluation is indicated by an index assuming the result of Comparative Example 1 to be 100. The results are shown in Tables 4 and 5.

Charge and discharge voltage: 2.5 to 4.2 V
Charging: A constant voltage is maintained at 0.5 C at 4.2 V until a charge current reaches 1/10.

### Discharging: 1 C

TABLE 4

| | Example | | | | | | | | | | | Com. Ex. |
|---|---|---|---|---|---|---|---|---|---|---|---|---|
| | 1 | 2 | 3 | 4 | 5 | 9 | 12 | 18 | 20 | 21 | 24 | 1 |
| Electrolytic solution | | | | | | | | | | | | |
| Solvent components | | | | | | | | | | | | |
| Component (A) | | | | | | | | | | | | |
| Kind | A1 | A1 | A1 | A2 | A2 | A1 | A1 | A2 | A2 | A2 | A2 | — |
| Content (vol. %) | 40 | 30 | 50 | 30 | 40 | 40 | 40 | 40 | 40 | 40 | 40 | — |
| Component (B) | | | | | | | | | | | | |
| Kind | B1a | B1a | B1a | B1a | B1a | B1a | B1a | — | B1a | B1a | B1b | — |
| Content (vol. %) | 5 | 5 | 5 | 5 | 5 | 5 | 5 | — | 3 | 3 | 5 | — |
| Component (C1) | | | | | | | | | | | | |
| Kind | C1a | C1a | C1a | C1a | C1a | C1a | C1a + C1c | C1a + C1c | C1a + C1c | C1a + C1c | C1a + C1c | C1a |
| Content (vol. %) | 10 | 10 | 10 | 10 | 10 | 10 | 10 + 10 | 10 + 10 | 12 + 10 | 12 + 10 | 10 + 10 | 30 |
| Component (C2) | | | | | | | | | | | | |
| Kind | C2a | C2a | C2a | C2a | C2a | C2a | C2a | C2a | C2a | C2a | C2a | C2a |
| Content (vol. %) | 45 | 55 | 35 | 55 | 45 | 35 | 35 | 30 | 35 | 32 | 35 | 70 |
| Component (D) | | | | | | | | | | | | |
| Kind | — | — | — | — | — | D2 | — | D2 | — | — | — | — |
| Content (vol. %) | — | — | — | — | — | 10 | — | 5 | — | — | — | — |
| Component (G) | | | | | | | | | | | | |
| Kind | — | — | — | — | — | — | — | — | — | G1 | — | — |
| Content (vol. %) | — | — | — | — | — | — | — | — | — | 3 | — | — |
| Electrolyte salt | | | | | | | | | | | | |
| (concentration: | | | | | | | | | | | | |
| mole/liter) | | | | | | | | | | | | |
| IIa | — | — | — | — | — | — | — | — | 0.3 | — | — | — |
| IIb | 1 | 1 | 1 | 1 | 1 | 1 | 1 | 1 | 0.7 | 1 | 1 | 1 |
| 3: Charge-discharge | 94 | 93 | 90 | 95 | 92 | 94 | 95 | 93 | 94 | 92 | 95 | 100 |
| characteristics (coin) | | | | | | | | | | | | |
| 4: Flame retardancy | | | | | | | | | | | | |
| test | | | | | | | | | | | | |
| Nail piercing test | ◯ | ◯ | ◯ | ◯ | ◯ | ◯ | ◯ | ◯ | ◯ | ◯ | ◯ | X |
| Over-charge test | ◯ | ◯ | ◯ | ◯ | ◯ | ◯ | ◯ | ◯ | ◯ | ◯ | ◯ | X |
| Short-circuit test | ◯ | ◯ | ◯ | ◯ | ◯ | ◯ | ◯ | ◯ | ◯ | ◯ | ◯ | X |
| 5: Ignition test | ◯ | ◯ | ◯ | ◯ | ◯ | ◯ | ◯ | ◯ | ◯ | ◯ | ◯ | X |
| 6: Charge-discharge | 93 | 96 | 88 | 92 | 90 | 88 | 92 | 90 | 91 | 87 | 91 | 100 |
| characteristics | | | | | | | | | | | | |
| (Cylinder) | | | | | | | | | | | | |

TABLE 5

| | Example | | | | | | | | | |
|---|---|---|---|---|---|---|---|---|---|---|
| | 26 | 27 | 28 | 29 | 30 | 31 | 32 | 33 | 34 | 35 |
| Electrolytic solution | | | | | | | | | | |
| Solvent components | | | | | | | | | | |
| Component (A) | | | | | | | | | | |
| Kind | A3 | A3 | A3 | A3 | A4 | A4 | A2 | A2 | A2 | A2 |
| Content (vol. %) | 30 | 30 | 30 | 40 | 30 | 40 | 30 | 40 | 30 | 30 |
| Component (B) | | | | | | | | | | |
| Kind | B1c | B2 | B2 + B1b | B2 + B1b | B2 + B1b | B2 | B2 | B2 | B1b | B1b |
| Content (vol. %) | 10 | 5 | 10 + 10 | 5 + 10 | 10 + 10 | 10 | 10 | 5 | 10 | 10 |
| Component (C1) | | | | | | | | | | |
| Kind | C1a + C1b | C1a | C1a | C1a | C1a | C1a + C1c | C1a + C1c | C1a + C1c | C1a + C1c | C1a + C1c |
| Content (vol. %) | 10 + 3 | 10 | 10 | 10 | 10 | 10 + 10 | 10 + 10 | 10 + 10 | 10 + 10 | 10 + 10 |
| Component (C2) | | | | | | | | | | |
| Kind | C2a | C2a | C2a | C2a | C2a | C2a | C2a | C2a | C2b | C2c |
| Content (vol. %) | 47 | 55 | 40 | 35 | 40 | 30 | 35 | 30 | 40 | 40 |
| Component (D) | | | | | | | | | | |
| Kind | — | — | — | — | — | — | D1 | D1 | — | — |
| Content (vol. %) | — | — | — | — | — | — | 5 | 5 | — | — |
| Component (E) | | | | | | | | | | |
| Kind | E1a | E1a | E1a | E1a | E1a | E1a | E1a | E1a | E1b | E1b |
| Content (vol. %) | 0.2 | 0.2 | 0.2 | 0.2 | 0.2 | 0.2 | 0.2 | 0.2 | 0.2 | 0.2 |
| Electrolyte salt | | | | | | | | | | |
| (concentration: | | | | | | | | | | |
| mole/liter) | | | | | | | | | | |
| IIa | 0.2 | 0.2 | 0.2 | 0.2 | 0.2 | 0.2 | 0.2 | 0.4 | 0.4 | 0.4 |
| IIb | 0.8 | 0.8 | 0.8 | 0.8 | 0.8 | 0.8 | 0.8 | 0.6 | 0.6 | 0.6 |
| 1: Solubility of | ◯ | ◯ | ◯ | ◯ | ◯ | ◯ | ◯ | ◯ | ◯ | ◯ |
| electrolyte salt | | | | | | | | | | |
| 2: Stability at low | ◯ | ◯ | ◯ | ◯ | ◯ | ◯ | ◯ | ◯ | ◯ | ◯ |
| temperature | | | | | | | | | | |
| 3: Charge-discharge | 93 | — | 92 | — | — | 93 | — | 92 | — | 94 |
| characteristics (coin) | | | | | | | | | | |
| 4: Flame retardancy | | | | | | | | | | |
| test | | | | | | | | | | |
| Nail piercing test | ◯ | — | ◯ | — | — | ◯ | — | ◯ | — | ◯ |
| Over-charge test | ◯ | — | ◯ | — | — | ◯ | — | ◯ | — | ◯ |
| Short-circuit test | ◯ | — | ◯ | — | — | ◯ | — | ◯ | — | ◯ |
| 5: Ignition test | ◯ | — | ◯ | — | — | ◯ | — | ◯ | — | ◯ |

### Examples 36 to 40 and Comparative Example 2

Electrolytic solutions of the present invention were prepared in the same manner as in Example 1 except that Components (A) to (G) and the electrolyte salt (II) were changed to those shown in Table 6.

By using these electrolytic solutions, solubility of electrolyte, stability at low temperature and charge-discharge characteristics (coin) were evaluated, and flame retardancy test (nail piercing test, over-charge test, short-circuit test) was carried out. The results are shown in Table 6.

TABLE 6

| | Example | | | | | Com. Ex. |
|---|---|---|---|---|---|---|
| | 36 | 37 | 38 | 39 | 40 | 2 |
| Electrolytic solution | | | | | | |
| Solvent components | | | | | | |
| Component (A) | | | | | | |
| Kind | A3 | A3 | A3 | A3 | A3 | A3 |
| Content (vol. %) | 20 | 20 | 20 | 20 | 20 | 5 |
| Component (B) | | | | | | |
| Kind | B1b | B1b | B1b | B1b | B1b | B1a |
| Content (vol. %) | 5 | 10 | 2 | 20 | 10 | 5 |
| Component (C1) | | | | | | |
| Kind | C1a | C1a | C1a | C1a | C1a | C1a |
| Content (vol. %) | 20 | 10 | 18 | 5 | 10 | 25 |
| Component (C2) | | | | | | |
| Kind | C2c | C2c | C2c | C2c | C2c | C2c |
| Content (vol. %) | 47 | 55 | 40 | 35 | 40 | 63 |
| Component (G) | | | | | | |
| Kind | — | — | — | — | G3 | — |
| Content (vol. %) | — | — | — | — | 10 | — |
| Kind | G5 | G5 | G5 | G5 | G5 | G5 |
| Content (vol. %) | 2 | 2 | 2 | 2 | 2 | 2 |
| Electrolyte salt | | | | | | |
| (concentration: mole/liter) | | | | | | |
| IIb | 1.0 | 1.0 | 1.0 | 1.0 | 1.0 | 1.0 |
| 1: Solubility of electrolyte salt | ◯ | ◯ | ◯ | ◯ | ◯ | ◯ |
| 2: Stability at low temperature | ◯ | ◯ | ◯ | ◯ | ◯ | ◯ |
| 3: Charge-discharge | 94 | 93 | 95 | 94 | 96 | 95 |
| characteristics (coin) | | | | | | |
| 4: Flame retardancy test | | | | | | |
| Nail piercing test | ◯ | ◯ | ◯ | ◯ | ◯ | X |
| Over-charge test | ◯ | ◯ | ◯ | ◯ | ◯ | X |
| Short-circuit test | ◯ | ◯ | ◯ | ◯ | ◯ | X |

### Examples 41 to 44

Electrolytic solutions of the present invention were prepared in the same manner as in Example 1 except that Component (A) to Component (G) and the electrolyte salt (II) were changed to those shown in Table 7.

By using these electrolytic solutions, solubility of electrolyte, stability at low temperature and charge-discharge characteristics (coin) were evaluated, and flame retardancy test (nail piercing test, over-charge test, short-circuit test) and ignition test were carried out. Also, a flash point was measured. The results are shown in Table 7.

### Test Example 7

### Measurement of Flash Point

A flash point of the electrolytic solution is measured with a tag closed type flash point meter. In the measurement, a temperature of the electrolytic solution is elevated until it is boiled and measurement cannot be carried out, and when a flash point is not measured, it is indicated by “nil”. It is to be noted that a flash point of the electrolytic solution of Comparative Example 1 was 24° C.

TABLE 7

| | Example | | | |
|---|---|---|---|---|
| | 41 | 42 | 43 | 44 |
| Electrolytic solution | | | | |
| Solvent components | | | | |
| Component (A) | | | | |
| Kind | A3 | A3 | A3 | A3 |
| Content (vol. %) | 40 | 40 | 40 | 40 |
| Component (B) | | | | |
| Kind | B1b | B1b | B1b | B1b |
| Content (vol. %) | 40 | 30 | 10 | 30 |
| Component (C1) | | | | |
| Kind | — | — | C1a | — |
| Content (vol. %) | — | — | 20 | — |
| Component (C2) | | | | |
| Kind | C2c | C2c | C2c | C2c |
| Content (vol. %) | 20 | 30 | 30 | 15 |
| Component (G) | | | | |
| Kind | — | — | — | G4 |
| Content (vol. %) | — | — | — | 15 |
| Electrolyte salt | | | | |
| (concentration: mole/liter) | | | | |
| IIb | 1.0 | 1.0 | 1.0 | 1.0 |
| 1: Solubility of electrolyte salt | ◯ | ◯ | ◯ | ◯ |
| 2: Stability at low temperature | ◯ | ◯ | ◯ | ◯ |
| 3: Charge-discharge characteristics (coin) | 89 | 93 | 90 | 94 |
| 4: Flame retardancy test | | | | |
| Nail piercing test | ◯ | ◯ | ◯ | ◯ |
| Over-charge test | ◯ | ◯ | ◯ | ◯ |
| Short-circuit test | ◯ | ◯ | ◯ | ◯ |
| 5: Ignition test | ◯ | ◯ | ◯ | ◯ |
| 7: Flash point | Nil | Nil | Nil | Nil |

### Test 8

### (Measurement of Internal Impedance)

### (Preparation of Double Pole Cell)

An active material for a positive electrode prepared by mixing LiCoO₂, carbon black and polyvinylidene fluoride (trade name KF-1000 available from KUREHA CORPORATION) in a ratio of 90/3/7 (mass percent ratio) was dispersed in N-methyl-2-pyrrolidone to be formed into a slurry which was then uniformly coated on a current collector of a positive electrode (15 μm thick aluminum foil) and dried to form a layer made of a mixture of positive electrode materials. Then, the coated current collector was subjected to compression molding with a roller press, and after cutting, a lead was welded thereto to prepare a strip-like positive electrode.

A styrene-butadiene rubber dispersed in distilled water was added to artificial graphite powder (trade name MAG-D available from Hitachi Chemical Co., Ltd.) to give a solid content of 6% by mass, followed by mixing with a disperser to be formed into a slurry which was then uniformly coated on a current collector of a negative electrode (10 μm thick copper foil) and dried to form a layer made of a mixture of negative electrode materials. Then, the coated copper foil was subjected to compression molding with a roller press, and after cutting and drying, a lead was welded thereto to prepare a strip-like negative electrode.

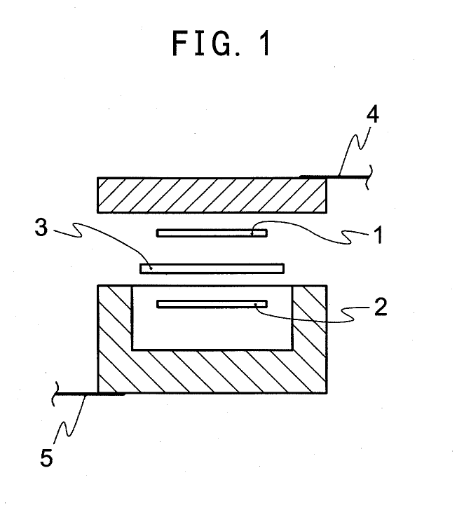

The strip-like positive electrode and negative electrode were cut into a size of 16 mm diameter, and a 20 μm thick microporous polyethylene film was cut into a size of 25 mm diameter to make a separator. These were combined as shown in the diagrammatic cross-sectional view of FIG. 1 to prepare a double pole cell. In FIG. 1, numeral 1 is a positive electrode, numeral 2 is a negative electrode, numeral 3 is a separator, numeral 4 is a terminal of a positive electrode, and numeral 5 is a terminal of a negative electrode. To this cell was poured 2 ml each of electrolytic solutions prepared in Examples 41 and 44 and Comparative Example 1, followed by sealing of the cell. A capacity of the cell is 3 mAh. After sufficient impregnation of the separator, etc., chemical conversion treatment was carried out to prepare a double pole cell.

### (A.C. Impedance Method)

In Measuring A.C. Impedance, the Double Pole Cell is charged (SOC=100%) at 1.0 C at 4.2 V until a charging current reaches 1/10 C. Thereafter, an internal impedance of the cell is measured with a frequency analyzer (model 1260 available from SOLARTRON) and a potentio-galvanostat (model 1287 available from SOLARTRON). Measuring conditions are an amplitude of ±10 mV and a frequency of 0.1 Hz to 2 kHz.

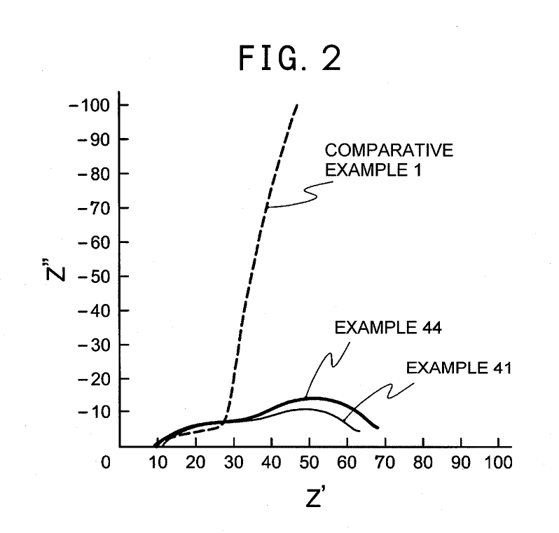

With respect to the obtained measured values of internal impedance, a real part (Z′) of the internal impedance value (Ω) is plotted on X-axis, and an imaginary part (Z″) of the internal impedance value is plotted on Y-axis to make a graph (Cole-Cole-Plot). FIG. 2 shows an obtained shape of plots.

From the results shown in FIG. 2, it is seen that in the electrolytic solution of Comparative Example 1, decomposition occurred and an internal resistance was increased, and therefore, the cell does not work normally.

### Test Example 9

### Discharge Curve

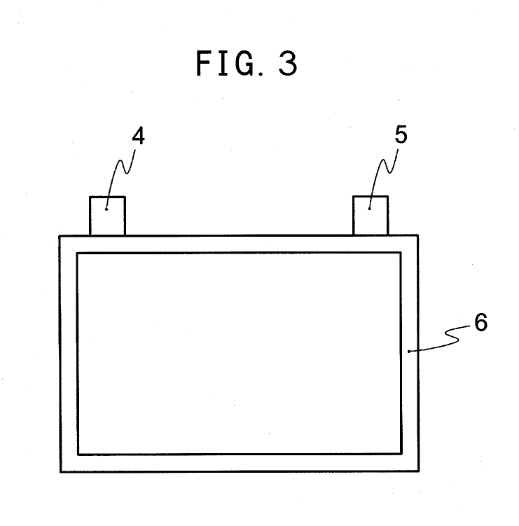

As shown in the diagrammatic plan view of FIG. 3, the strip-like positive electrode made in Test Example 8 was cut into a size of 40 mm×72 mm (with a 10 mm×10 mm terminal for the positive electrode), and the strip-like negative electrode was cut into a size of 42 mm×74 mm (with a 10 mm×10 mm terminal for the negative electrode). Then, a lead was welded to each terminal. Also, a 20 ™ thick microporous polyethylene film was cut into a size of 78 mm×46 mm to make a separator. The positive electrode and the negative electrode were set so that the separator was sandwiched between them, and these were put in an aluminum-laminated packaging material 6 as shown in FIG. 3. Then, 2 ml each of the electrolytic solutions prepared in Example 1 and Comparative Example 1 was poured into the packaging material 6, followed by sealing. Thus, a laminated cell having a capacity of 72 mAh was prepared.

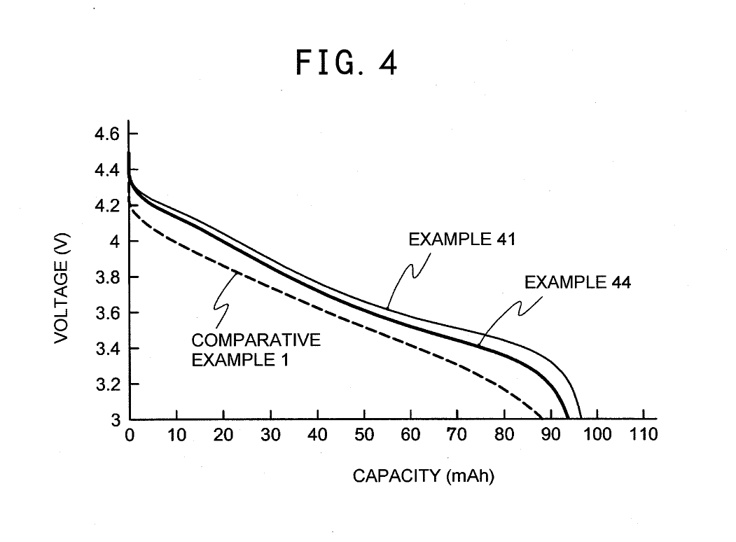

The cell was charged at 1.0 C at 4.2 V until a charging current reached 1/10 C and was discharged up to 3.0 V at a current equivalent to 1.0 C. By plotting on a graph, a discharge curve shown in FIG. 4 was obtained. From FIG. 4, it is seen that in the case of the electrolytic solution of Comparative Example 1, resistance is high and rate characteristics are lowered.

### INDUSTRIAL APPLICABILITY

The present invention can provide an electrolytic solution causing no phase separation even at low temperatures, being excellent in flame retardancy and noncombustibility, assuring high solubility of an electrolyte salt, having a high discharge capacity, being excellent in charge-discharge cycle characteristics and being suitable for electrochemical devices such as lithium ion secondary batteries because the electrolytic solution comprises the specific fluorine-containing ether (A), the specific fluorine-containing solvent (B) and the non-fluorine-containing cyclic carbonate (C).

1. An electrolytic solution comprising:
(I) a solvent for dissolving an electrolyte salt comprising:
(A) a fluorine-containing ether represented by the formula (A):
Rf¹—O—Rf²
wherein Rf¹ and Rf² are the same or different, Rf¹ is a fluorine-containing alkyl group having 3 to 6 carbon atoms, Rf² is a fluorine-containing alkyl group having 2 to 6 carbon atoms,
(B) at least one fluorine-containing solvent selected from the group consisting of (B1) a fluorine-containing cyclic carbonate and (B2) a fluorine-containing lactone, and
(C) at least one non-fluorine-containing carbonate selected from the group consisting of (C1) a non-fluorine-containing cyclic carbonate and (C2) a non-fluorine-containing chain carbonate, and
(II) an electrolyte salt,
said solvent (I) for dissolving an electrolyte salt comprises 20 to 60% by volume of the fluorine-containing ether (A), 0.5 to 45% by volume of the fluorine-containing solvent (B), and 5 to 40% by volume of the non-fluorine-containing cyclic carbonate (C1) and/or 10 to 74.5% by volume of the non-fluorine-containing chain carbonate (C2) based on the whole solvent (I).

2. The electrolytic solution of claim 1, wherein a fluorine content of the fluorine-containing ether (A) represented by the formula (A) is 40 to 75% by mass, and in the formula (A), Rf¹ and Rf² are the same or different, Rf¹ is a fluorine-containing alkyl group having 3 or 4 carbon atoms, and Rf² is a fluorine-containing alkyl group having 2 or 3 carbon atoms.

3. The electrolytic solution of claim 1, wherein a boiling point of the fluorine-containing ether (A) is 67° to 120° C.

4. The electrolytic solution of claim 1, wherein the fluorine-containing ether (A) is at least one selected from the group consisting of HCF₂CF₂CH₂OCF₂CFHCF₃, CF₃CF₂CH₂OCF₂CFHCF₃, HCF₂CF₂CH₂OCF₂CF₂H and CF₃CF₂CH₂OCF₂CF₂H.

5. The electrolytic solution of claim 1, wherein the non-fluorine-containing cyclic carbonate (C1) is at least one selected from the group consisting of ethylene carbonate, vinylene carbonate and propylene carbonate, and the non-fluorine-containing chain carbonate (C2) is at least one selected from the group consisting of dimethyl carbonate, diethyl carbonate and methyl ethyl carbonate.

6. The electrolytic solution of claim 1, wherein (D) a phosphoric ester is contained in the solvent (I) for dissolving an electrolyte salt in an amount of 1 to 10% by volume.

7. The electrolytic solution of claim 6, wherein the phosphoric ester (D) is (D1) a fluorine-containing alkyl phosphate.

8. The electrolytic solution of claim 1, comprising:
(E) at least one surfactant selected from the group consisting of (E1) fluorine-containing carboxylates represented by the formula (E1):
Rf⁷COO⁻M⁺
wherein Rf⁷ is a fluorine-containing alkyl group which has 3 to 12 carbon atoms and may have ether bond; M⁺ is Li⁺, Na⁺, K⁺ or NHR′₃⁺ (R′ are the same or different and each is H or an alkyl group having 1 to 3 carbon atoms), and
(E2) fluorine-containing sulfonates represented by the formula (E2):
Rf⁸SO₃⁻M⁺
wherein Rf⁸ is a fluorine-containing alkyl group which has 3 to 10 carbon atoms and may have ether bond; M⁺ is Li⁺, Na⁺, K⁺ or NHR′₃⁺ (R′ are the same or different and each is H or an alkyl group having 1 to 3 carbon atoms),
in an amount of 0.01 to 2% by mass based on the whole solvent (I) for dissolving an electrolyte salt.

9. The electrolytic solution of claim 1, comprising 1 to 30% by volume of a propionic acid ester.

10. The electrolytic solution of claim 1, comprising 0.1 to 5% by volume of an aromatic compound.

11. The electrolytic solution of claim 1, wherein a concentration of the electrolyte salt (II) is 0.5 to 1.5 mole/liter.

12. The electrolytic solution of claim 1, wherein the electrolyte salt (II) is LiPF₆ or LiBF₄.

13. The electrolytic solution of claim 1, wherein the electrolyte salt (II) comprises (IIa) at least one electrolyte salt selected from the group consisting of LiN(SO₂CF₃)₂ and LiN(SO₂CF₂CF₃)₂.

14. The electrolytic solution of claim 13, wherein the electrolyte salt (IIa) is LiN(SO₂CF₃)₂.

15. The electrolytic solution of claim 13, further comprising (IIb) at least one electrolyte salt selected from the group consisting of LiPF₆ and LiBF₄.

16. The electrolytic solution of claim 15, wherein a concentration of the electrolyte salt (IIa) is 0.1 to 0.9 mole/liter, a concentration of the electrolyte salt (IIb) is 0.1 to 0.9 mole/liter and a ratio of the concentration of the electrolyte salt (IIb)/the concentration of the electrolyte salt (IIa) is 1/9 to 9/1.

17. The electrolytic solution of claim 1, which is used for a lithium ion secondary battery.

18. An electrochemical device provided with the electrolytic solution of claim 1.

19. A lithium ion secondary battery provided with the electrolytic solution of claim 1.

20. The lithium ion secondary battery of claim 19, further provided with a positive electrode, a negative electrode and a separator.

21. The lithium ion secondary battery of claim 20, wherein an active material used on the positive electrode is at least one selected from the group consisting of cobalt compound oxides, nickel compound oxides, manganese compound oxides, iron compound oxides and vanadium compound oxides.

22. The lithium ion secondary battery of claim 20, wherein an active material used on the negative electrode is a carbon material.
